(19) United States
(12) Patent Application Publication
(10) Pub. No.: US 2009/0216570 A1
(43) Pub. Date: Aug. 27, 2009

(54) TRAVEL RESERVATION SYSTEM AND METHOD

(76) Inventor: Brian L. MacKenzie, Pomfret Center, CT (US)

Correspondence Address: W. EDWARD RAMAGE, COMMERCE CENTER SUITE 1000, 211 COMMERCE ST, NASHVILLE, TN, 37201, US

(21) Appl. No.: 12/394,737

(22) Filed: Feb. 27, 2009

Related U.S. Application Data
(60) Provisional application No. 61/031,936, filed on Feb. 27, 2008.

(51) Int. Cl. G06Q 10/00; G06F 17/30; G06Q 50/00

(52) U.S. Cl. 705/5; 707/104.1; 707/3; 707/E17.009; 707/E17.014

(57) ABSTRACT

A system and method to identify Small and Disadvantaged Business (SDB) travel suppliers and account for the SDB expenditures. SDB suppliers submit their information to the system for inclusion in an SDB database. Initially, the suppliers self-certify their status. Status may be subsequently verified by the system operator or a third party. Certified SDB data is supplied to the Global Distribution System (GDS) and/or travel companies and agents. SDB status is used as a search attribute by travelers and travel managers. Reports may be provided to travelers and travel managers regarding spending with SDB businesses. Reports also may be provided to SDB businesses.

This application claims priority to Provisional Patent Application No. 61/031,936, filed Feb. 27, 2008, by Brian MacKenzie, et al. and is entitled in whole or in part to that filing date for priority. The specification, drawings, and complete disclosure of Provisional Patent Application No. 61/031,936 are incorporated herein in their entireties by reference.

### FIELD OF INVENTION

This invention relates to a system and related method for travel reservations. More specifically, the present invention relates to a system and related method for selecting lodging and automobile rental suppliers based on their status as small or disadvantaged businesses.

### SUMMARY OF INVENTION

In one exemplary embodiment, the present invention comprises a system and method for such travelers to easily identify small disadvantaged business (SDB) travel suppliers (e.g., lodging and automobile rental companies) and account for the SDB expenditures. Conversely, the system assists SDB owners and operators with securing business travel based upon their SDB status.

SDB suppliers submit their information to the system for inclusion in an SDB database. Initially, the suppliers self-certify their status. Status may be subsequently verified by the system operator or a third party.

Certified SDB data is supplied to the Global Distribution System (GDS) and/or travel companies and agents. SDB status is used as a search attribute by travelers and travel managers. Reports may be provided to travelers and travel managers regarding spending with SDB businesses. Reports also may be provided to SDB businesses.

### BRIEF DESCRIPTION OF THE DRAWINGS

FIG. 1 shows a diagram of a system in accordance with an exemplary embodiment of the present invention.

### DETAILED DESCRIPTION OF EXEMPLARY EMBODIMENTS

Many government and corporate travelers are subject to regulations or requirements to use small disadvantaged businesses (SDBs), as defined by the Small Business Administration (SBA), in their travel. Similarly, many corporations may prefer to use SDBs as part of Corporate Social Responsibility (CSR) programs. As described in detail below, various embodiments of the present invention allow corporate travel management to add SDB procurement to traditional travel management values, thereby promoting ethical business standards throughout the travel supply chain.

In one exemplary embodiment, the present invention comprises a system and method for such travelers to easily identify SDB travel suppliers (e.g., hotels and motels 2, automobile rental companies 4, and the like) and account for the SDB expenditures. Conversely, the system assists SDB owners and operators with securing business travel based upon their SDB status.

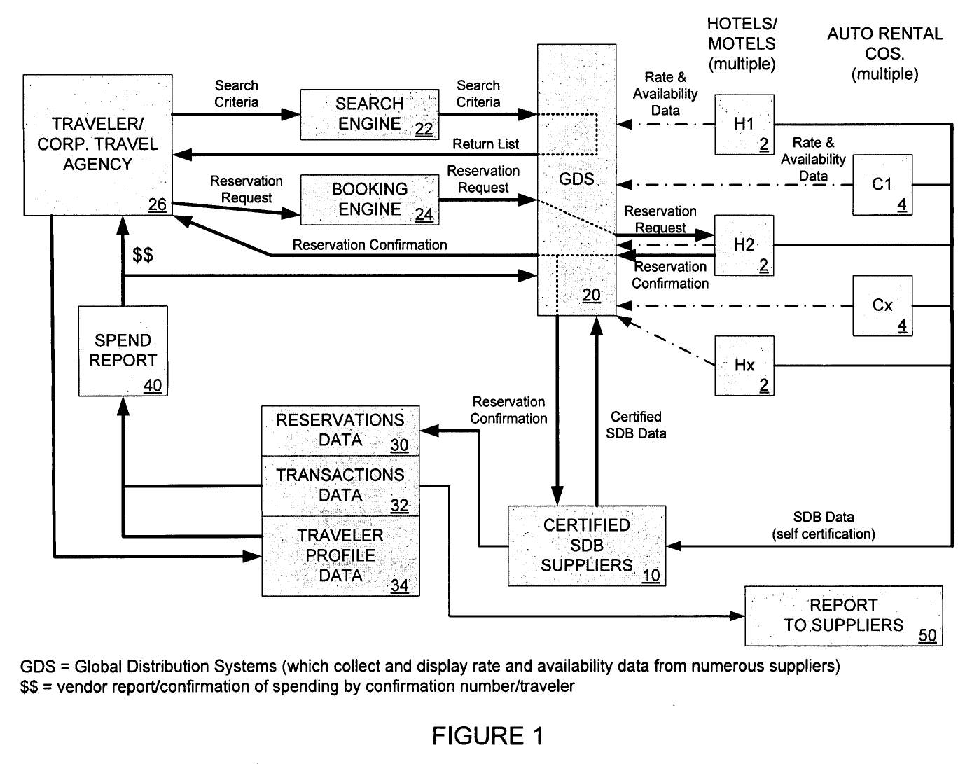

As seen in FIG. 1, in one embodiment, the system comprises a database 10 of SDB hotel and auto rental suppliers 2, 4. The database may reside on one or more database servers, or on one or more data storage devices, such as hard drives, as part of a computer system. Suppliers submit relevant data to the database, including their status as an SDB.

In one embodiment, the suppliers initially self-certify their status. The certification standards and procedures may comply with SBA rules for self certification of SDBs. Other relevant or equivalent standards and procedures may be applied. The certification process also may allow for the inclusion of franchisees of major hotel and automobile rental chains.

The initial self-certification may be subjected to a review and certification by the operator of the database or a third party. This subsequent review may include review of data from participating hotel/motel and automobile rental chains, and data from various organizations (including, but not limited to, the Asian American Hotel Owners Association (AAHOA), the National Association of Black Hotel Owners, Operators and Developers (NABHOOD), and the Hispanic Hotel Owners Association). This review may also further comprise due diligence investigation of the business' size and ownership status.

SDB qualification criteria may vary. In one embodiment, the SBA grants SDB status to hotels with less than $7M in annual revenue, and car rental businesses with less that $25.5M in annual revenue. Disadvantaged ownership status is granted to a business with at least 51% women, minority or veteran ownership and active management.

Suppliers may submit their information to the system in a variety of ways. In one embodiment, suppliers may enter their information through an internet web site or application. The database operator updates the information on a periodic basis, which may be daily or some other appropriate time period. Suppliers may be charged a fee for participation in the system.

The system provides certified SDB status data to the Global Distribution System (GDS) 20. The SDB status thereby becomes a new attribute (or attributes) to be used by travelers or corporate travel agencies when searching for travel suppliers (such as through a search engine 22) and when making a selection and reservation (such as through a booking engine 24).

In yet another embodiment, the system further comprises an internet travel site where status as a SDB is a prerequisite for displaying location, rate, and availability data.

In one exemplary embodiment, the travel reservation system, as applied to hotel rooms, comprises four steps. First, the traveler (or agency) 26 supplies information to the search and booking engines 22, 24 regarding his or her requirements for a reservation, including location and date (i.e., where a hotel room is needed, and when). Price may also be a requirement. The traveler also supplies information about himself or herself, and the purpose of his or her travel, including an identifier for the government contract or program for which enhanced compliance is sought. This information may be stored in a traveler profile database 34, which may be stored on the same data storage device as the SDB database.

Second, the search and booking engines 22, 24, which may comprise a commercially available software package, accesses the inventory of available hotel rooms on either the GDS 20 (i.e., a large legacy system which contains rate and availability information for thousands of hotels of all types), or on the individual websites of hotel owners and franchisors. The search engine returns a list of hotels (i.e., the “return list”) which meet the traveler's criteria. The return list may be sent to or received by the computer housing the SDB database or by the GDS.

Third, the return list is compared to the SDB database, which may be certified as discussed above. All matches are transmitted to the traveler. If no matches are available, that information is communicated to the traveler, and other hotels may be transmitted.

Fourth, the traveler selects a hotel from the list of hotels presented and engages the booking engine 24 to make and confirm a reservation for the date(s) and type of room desired. The confirmation number is captured and stored in the reservation/transaction databases 30, 32.

The process with rental cars is nearly identical to the above. The most significant difference is in the original search criteria supplied by the traveler, where car type, price, and optional features are the primary inputs beyond location and date.

The system further enables the tracking of monies spent with SDB suppliers, and the reporting 40 of that spending back to the traveler or the traveler's employer. The system also may collect spending data from the hotels and rental car agencies to which it has referred travelers. Data elements collected may include confirmation number and the associated amount spent. On a period basis, reports may be generated from the traveler profile and reservation/transaction data, identifying the amounts spent with SDBs in connection with each government contract or program. By using the system in this manner, the business or government agency can then present certified spending data to the SBA (in the case of government users) or contracting-agency auditors (in the case of businesses), measuring the extent of compliance with SDB spending goals. The system may also provide reports and performance data 50 to the travel supplier (or suppliers) as to the utility of the system in providing new reservations based on business size and ownership status. Fees may be charged for reports.

In yet another embodiment, SDB certification data and content may be licensed to travel management companies. Revenue may be generated from a licensing fee for providing this content. The database may be available to the travel management companies in real-time or by a periodic (e.g., daily) download of data to the travel management company.

Accordingly, the system of the present invention may direct government and corporate travelers to SDB travel suppliers, report SDB spending to travel departments, and provide performance data to the travel suppliers. The operator of the system may generate revenue by licensing fees with travel management companies or corporations, transactional fees, and travel supplier fees.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

I claim:

1. A computer-based system, comprising:
a database of travel suppliers certified as small disadvantaged businesses, wherein the database resides on a computer storage device.

2. The system of claim 1, wherein the travel suppliers are certified as small disadvantaged businesses by the operator of the system.

3. The system of claim 1, wherein the travel suppliers are certified as small disadvantaged businesses by a third party.

4. The system of claim 1, wherein the travel suppliers are certified as small disadvantaged businesses based on Small Business Administration rules or regulations.

5. The system of claim 1, wherein travel suppliers initially self-certify that they are qualified as small disadvantaged businesses.

6. The system of claim 1, wherein data identifying certified small disadvantaged business travel suppliers is provided to travel management companies or a Global Distribution System.

7. The system of claim 1, wherein data identifying certified small disadvantaged business travel suppliers is used to identify such travel suppliers in response to search requests.

8. The system of claim 1, wherein data identifying certified small disadvantaged business travel suppliers is used to make reservations with such travel suppliers.

9. The system of claim 1, further comprising a database of transaction information, wherein the transactions involved small disadvantaged business travel suppliers.

10. The system of claim 9, further comprising a database of traveler information, wherein the travelers use small disadvantaged business travel suppliers.

11. The system of claim 10, wherein the system provides information identifying the amount of money spent at certified small disadvantaged business travel suppliers for a particular traveler, department, or company.

12. The system of claim 11, wherein the information is provided in the form of a written report.

13. The system of claim 9, wherein the system provides information identifying the amount of money spent at a certified small or disadvantaged business travel supplier to that supplier.

14. The system of claim 13, wherein the information is provided in the form of a written report.
